(19) United States
(12) Patent Application Publication
(10) Pub. No.: US 2017/0245001 A1
(43) Pub. Date: Aug. 24, 2017

(54) DISPLAY APPARATUS AND CONTROL METHOD THEREOF

(71) Applicant: SAMSUNG ELECTRONICS CO., LTD., Suwon-si (KR)

(72) Inventors: Eun-joo CHO, Hwaseong-si (KR); Myung-kwan CHOI, Suwon-si (KR)

(21) Appl. No.: 15/372,947

(22) Filed: Dec. 8, 2016

(30) Foreign Application Priority Data
Feb. 18, 2016 (KR) 10-2016-0019031

(51) Int. Cl. H04N 21/438; H04N 21/45; H04N 21/482; H04N 21/422; H04N 21/262; H04N 21/41

(52) U.S. Cl. CPC H04N 21/4383; H04N 21/26283; H04N 21/4104; H04N 21/4821; H04N 21/42224; H04N 21/4532

(57) ABSTRACT

A display apparatus is provided, including: a display; a signal receiver configured to receive a broadcast signal; an input comprising input circuitry including a channel changing key and configured to receive an input; and at least one processor configured to display an image of a first channel among a plurality of channels of the received broadcast signal on the display, and to switch from the first channel to another channel in response to a channel changing command input through the input while the image of the first channel is displayed, the at least one processor configured to process a user interface (UI) for guiding a second channel to be selectable to be displayed on the display if the channel changing key is input more than a predetermined number of times for a preset first time.

### CROSS-REFERENCE TO RELATED APPLICATION

This application is based on and claims priority under 35 U.S.C. to Korean Patent Application No. 10-2016-0019031 filed on Feb. 18, 2016 in the Korean Intellectual Property Office, the disclosure of which is incorporated by reference herein in its entirety.

### BACKGROUND

Field

The present disclosure relates generally to a display apparatus that receives a content signal such as a broadcast signal from an exterior and processes it to be displayed as an image and a control method thereof, and for example to a display apparatus, which has an improved structure for providing recommended content to a user while the user changes channels through a user input interface such as a remote controller, and a control method thereof.

Description of Related Art

To compute and process predetermined information in accordance with certain processes, an electronic apparatus basically includes a central processing unit (CPU), a chipset, a memory, and the like electronic components for computation. Such an electronic apparatus may be classified variously in accordance with what information will be processed therein. For example, the electronic apparatus is classified into an information processing apparatus such as a personal computer, a server or the like for processing general information, and an image processing apparatus for processing image information.

The image processing apparatus receives a content signal including image data from the exterior and processes the image data extracted from the content signal in accordance with various image processing processes. The image processing apparatus may display an image based on the processed image data on its own display panel, or output the processed image data to another display apparatus provided with a panel so that on the corresponding display apparatus can display an image based on the processed image signal. As a representative example of the image processing apparatus having no display panel, there is a set-top box. In particular, the image processing apparatus that has a display panel is called a display apparatus, and may for example includes a television (TV), a monitor, a portable multimedia player (PMP), a tablet, computer, a mobile phone, etc.

If a display apparatus is the television, the display apparatus is tuned to a certain channel to receive a broadcast signal and displays an image based on the received broadcast signal. Such a display apparatus includes a user input interface through which a user can make an instruction for various operations such as channel selection. As a representative example of the user input interface, there is a remote controller having various keys or buttons. Thus, a user directly inputs a channel number by pressing a numeral key on the remote controller, or selects a desired channel by repetitively pressing a channel up or down key.

In the case where a user directly inputs a channel number, the display apparatus is tuned to a frequency corresponding to the input channel number and thus receives a broadcast signal. This operation is called direct tuning. For the direct tuning, a user has to remember a channel number of a desired channel, but it may be difficult for a user to remember favorite channel numbers. On the other hand, a user may switch between channels without giving a thought to a specific channel. In this regard, a user can search a desired channel by channel zapping, channel surfing or the like operation of repetitively pressing the channel up or down key.

However, several hundreds of channels are available in reality, and it is thus inconvenient for a user to repetitively press the channel up or down key. Accordingly, there is a need of solving problems of the inconvenience in the display apparatus.

### SUMMARY

According to an aspect of an example embodiment, a display apparatus is provided, including: a display; a signal receiver configured to receive a broadcast signal; an input configured to include a channel changing key and to receive an input; and at least one processor configured to display an image of a first channel among a plurality of channels of the received broadcast signal on the display, and to switch from the first channel to another channel in response to a channel changing command input through the input while the image of the first channel is displayed, the at least one processor configured to process a user interface (UI) for guiding a second channel to be selectable to be displayed on the display if the channel changing key is input more than a predetermined number of times for a preset first time. Thus, the display apparatus recommends a channel of a specific broadcast program to a user in response to channel zapping, and allows easy selection of the recommended channel.

The at least one processor may process the UI for guiding the second channel to be selectable to be displayed on the display if the channel changing key is input more than a predetermined number of times within a preset second time after the first channel is switched to another channel.

The at least one processor may process the UI for guiding the second channel to be selectable to be displayed on the display if the channel changing key is input during a commercial break or if a remaining running time of a program displayed corresponding to the first channel is not greater than a predetermined value.

The at least one processor may select a channel of a broadcast program, which is selected based on preset priority, as the second channel among broadcast programs that can be broadcasted between a current time and a preset second time. Thus, the display apparatus can select a broadcast program, which is currently displayable, among various broadcast programs.

The priority may be determined by a user's preference based on a view history of a broadcast program. Thus, the display apparatus can select a broadcast program, which reflects a user's taste, as a recommended broadcast program.

The priority may be determined by ratings of a broadcast program.

The priority may be determined by similarity in genre of a broadcast program.

The at least one processor may process the UI for guiding the second channel to be selectable to be displayed on the display with respect to aperiodic inputs of the channel changing key.

The input may include a remote controller, and the channel changing command may be issued by an input of the channel changing key provided in the remote controller.

According to an aspect of another example embodiment, a method of controlling a display apparatus is provided, the method including: receiving a broadcast signal; displaying an image of a first channel among a plurality of channels of the broadcast signal; receiving an input including a channel changing command while the image of the first channel is displayed; switching from the first channel to another channel in response to the channel changing command; and displaying a user interface (UI) for guiding a second channel to be selectable if a channel changing key provided in a remote controller for the display apparatus is input more than a predetermined number of times for a preset first time. Thus, the display apparatus recommends a channel of a specific broadcast program to a user in response to channel zapping of the user, and allows the user to easily select the recommended channel.

The displaying the UI may include displaying the UI for guiding the second channel to be selectable if the channel changing key is input more than a predetermined number of times within a preset second time after the first channel is switched over to another channel.

The displaying the UI may include displaying the UI for guiding the second channel to be selectable if the channel changing key is input during a commercial break or if a remaining running time of a program displayed corresponding to the first channel is not greater than a predetermined value.

The displaying the UI may include selecting a channel of a broadcast program, which is selected based on preset priority, as the second channel among broadcast programs that can be broadcasted between a current time and a preset second time. Thus, the display apparatus can select a broadcast program, which is currently displayable, among various broadcast programs.

The priority may be determined by a user's preference based on a view history of a broadcast program. Thus, the display apparatus can select a broadcast program, which reflects a user's taste, as a recommended broadcast program.

The priority may be determined by ratings of a broadcast program.

The priority may be determined by similarity in genre of a broadcast program.

The displaying the UI may include displaying the UI for guiding the second channel to be selectable with respect to aperiodic inputs of the channel changing key.

### BRIEF DESCRIPTION OF THE DRAWINGS

The above and/or other aspects will become apparent and more readily appreciated from the following detailed description, taken in conjunction with the accompanying drawings, in which like reference numerals refer to like elements, and wherein:

FIG. 1 is a diagram illustrating an example display apparatus according to a first example embodiment;

FIG. 2 is a block diagram illustrating an example display apparatus according to the first example embodiment;

FIG. 3 is a flowchart illustrating an example controlling of a display apparatus according to a second example embodiment;

FIG. 4 is a diagram illustrating an example electronic program guide (EPG) information acquired by the display apparatus according to the second example embodiment;

FIG. 5 diagram illustrating an example display apparatus according to a third example embodiment that displays a broadcast image and a guide user interface (UI);

FIG. 6 is a diagram illustrating an example display apparatus according to the third example embodiment that displays an extended guide UI;

FIG. 7 is a diagram illustrating an example display apparatus according to a fourth example embodiment that displays a guide UI for showing additional information;

FIG. 8 is a diagram illustrating an example display apparatus according to the fourth example embodiment that displays an extended guide UI;

FIG. 9 is a diagram illustrating an example display apparatus according to a fifth example embodiment that displays an extended guide UI;

FIG. 10 is a diagram illustrating an example display apparatus according to a sixth example embodiment that displays a guide UI;

FIG. 11 is a diagram illustrating an example of channel zapping while a display apparatus according to a seventh example embodiment displays a broadcast program of a certain channel; and

FIG. 12 is a flowchart illustrating an example of controlling a display apparatus according to an eighth example embodiment.

### DETAILED DESCRIPTION

Below, example embodiments will be described in greater detail with reference to accompanying drawings. The following descriptions of the example embodiments are made by referring to elements shown in the accompanying drawings, in which like numerals refer to like elements having substantively the same functions.

In the description of the example embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the disclosure.

Further, the example embodiments will typically describe only elements directly related to the idea of the disclosure, and description of the other elements may be omitted. However, it will be appreciated that the elements, the descriptions of which are omitted, are not unnecessary to realize the apparatus or system according to the example embodiments. In the following descriptions, terms such as “include” or “have” refer to presence of features, numbers, steps, operations, elements or combination thereof, and do not exclude presence or addition of one or more other features, numbers, steps, operations, elements or combination thereof.

Further, the example embodiments respectively described with reference to the accompanying drawings are not exclusive to each other unless otherwise mentioned, and a plurality of embodiments may be selectively combined within one apparatus. The combination of these plural embodiments may be discretionally selected and applied to realize the present disclosure by a person having an ordinary skill in the art.

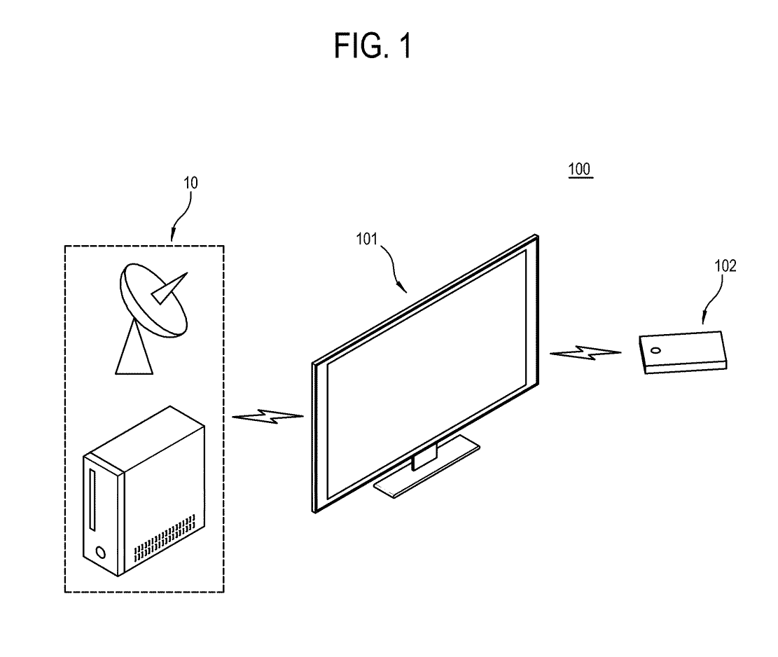

FIG. 1 is a diagram illustrating an example display apparatus 100 according to a first example embodiment.

As illustrated in FIG. 1, a display apparatus 100 according to a first example embodiment receives a content signal from various content sources 10. In this example embodiment, a content signal is a broadcast signal including broadcast programs corresponding to a plurality of channels, and the display apparatus 100 is a television (TV) which is tuned a specific channel to receive a broadcast signal and displays a broadcast program image based on the broadcast signal. However, this example embodiment is not the only one for realizing the present disclosure. Alternatively, a content signal may be a signal that includes not the broadcast program but a plurality of pieces of content data, and the display apparatus 100 may be an apparatus that processes content data and displays a content image based on the content data.

A network used for receiving a content signal such as a broadcast signal by the display apparatus 100 includes a broadcast network and a broadband network. The display apparatus 100 is achieved by a hybrid terminal connecting in parallel with the broadcast network and the broadband network. The broadband network uses a frequency band for streaming or downloading audio/video (A/V) content by an interactive Internet protocol (IP) access. The broadcast network uses classical unidirectional transmission such as a digital video broadcasting-terrestrial (DVB-T), DVB-satellite (S), DVB-cable (C), etc.

The display apparatus 100 can receive linear A/V content, non-real time A/V content, application data, and application signaling information, etc. through the broadcast network. Although the display apparatus 100 is not connected to the broadband network, the connection with the broadcast network allows the display apparatus 100 to receive a broadcast-related application. In addition, the broadcast network enables signaling of stream events with regard to an application.

Here, the broadcast-related application refers to a broadcast TV, radio or data channel, or an interactive application related to content of such a channel. On the other hand, a broadcast-independent application refers to an interactive application unrelated to any broadcast channel or other broadcast data.

Further, the display apparatus 100 may receive application data, nonlinear A/V content, etc. through the broadband network. Here, the nonlinear A/V content refers to content such as Streaming on Demand, of which view time or a play point of play within a running time are freely selected by a user, but the linear AV content refers to push-type content that a user can view in only specific time during which a provider provide it. Through the broadband network, the display apparatus 100 can communicate with external devices (not shown) connected to the same network.

Thus, the display apparatus 100 can receive a content signal from the content source 10 by a broadcast mode or a broadband mode.

Further, the display apparatus 100 includes various user input interfaces for allowing a user to control general operations of the display apparatus 100 such as image display. As a representative example of the user input interface, there is a remote controller 102 separated from a main body 101 of the display apparatus 100.

The remote controller 102 may include various elements such as a display, a touch screen, a touch pad, etc. in accordance with design methods. Basically, the remote controller 102 includes a plurality of keys or buttons to be manipulated by a user. Each key is provided to generate a control signal for controlling a preset operation. If a user presses a key, a control signal corresponding to the pressed key is transmitted from the remote controller 102 to the main body 101 of the display apparatus 100. Then, the display apparatus 100 performs an operation corresponding to such a control signal.

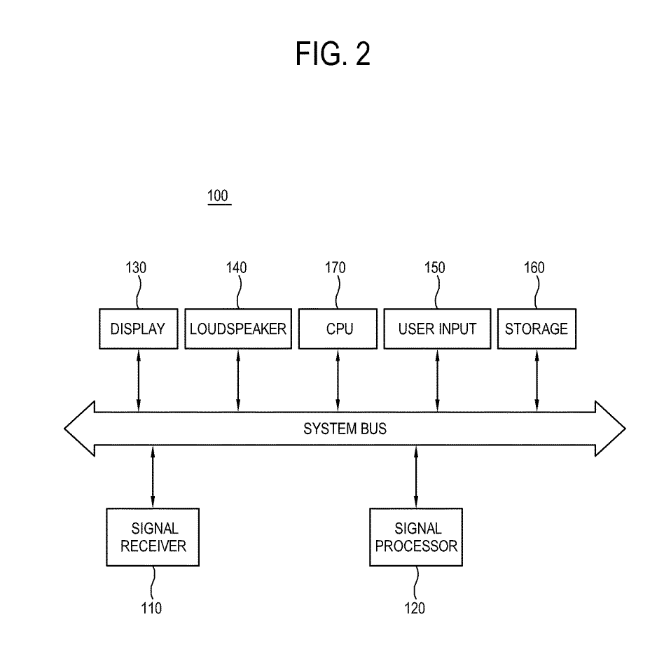

Below, hardware components of the display apparatus 100 will be described with reference to FIG. 2.

FIG. 2 is a block diagram illustrating an example display apparatus 100 according to the first example embodiment.

As illustrated in FIG. 2, the display apparatus 100 includes a signal receiver 110 which receives a broadcast signal in accordance with the broadcast or broadband mode, a signal processor (e.g., including processing circuitry) 120 which processes the broadcast signal received in the signal receiver 110, a display 130 which displays a broadcast image of a specific channel based on the broadcast signal processed by the signal processor 120, a loudspeaker 140 which output a broadcast sound of the specific channel based on the broadcast signal processed by the signal processor 120, a user input (e.g., including input circuitry) 150 which receiving a user's input, a storage 160 which stores data, and a central processing unit (CPU) (e.g., including processing circuitry) 170 which performs computations for the processes of the signal processor 120 and controls operations of the display apparatus 100. These elements are connected to each other through a system bus.

In this example embodiment, the CPU 170 is provided separately from the signal processor 120, but not limited thereto. Alternatively, the CPU 170 and the signal processor 120 may be integrated into a single system on chip (SOC).

The signal receiver 110 receives a broadcast signal in the broadcast mode. The signal receiver 110 is tuned to a frequency selected by the CPU 170 and receives a broadcast signal. To this end, the signal receiver 110 includes a tuning chip to be tuned to a radio frequency (RF) signal. Further, the signal receiver 110 may receive a broadcast signal in the broadband mode, and may for example receive packet data from a server (not shown) through the Internet. The signal receiver 110 supports at least one of a wired protocol and a wireless protocol. The signal receiver 110 includes an Ethernet module in the former case, or includes a wireless communication module in the latter case. The signal receiver 110 may include both the Ethernet module and the wireless communication module to cope with the wired protocol and the wireless protocol. The wireless communication module may for example support a Wi-Fi protocol.

The signal processor 120 includes various processing circuitry that applies various processes to a broadcast signal received in the signal receiver 110. The signal processor 120 extracts video data of a specific broadcast channel from a broadcast signal, applies a video processing process to the video data, and outputs the processed video data to the display 130 so that the display 130 can display an image.

The signal processor 120 performs various processes in accordance with the kinds or characteristics of signal or data. Therefore, the processes performable in the signal processor 120 are not limited to the video processing process, and the data processible in the signal processor 120 is not limited to only that received in the signal receiver 110. For example, the signal processor 120 applies an audio processing process to audio data of a specific broadcast channel extracted from a broadcast signal, and outputs the processed audio data to the loudspeaker 140. Further, if a user's utterance is input the display apparatus, the signal processor 120 applies a preset voice recognition process to the utterance. The signal processor 120 may be achieved by a SoC where various functions are integrated, or an image processing board (not shown) where individual chipsets capable of independently performing the respective processes are mounted to a printed circuit board.

The display 130 displays an image based on the video data processed by the signal processor 120. There are no limits to the kind of the display 130, and the display 130 may include a display panel having a light receiving structure like a liquid crystal display (LCD) or a light emitting structure like an organic light emitting diode (OLED), or the like, but is not limited thereto. Further, the display 130 may include elements in addition to the display panel in accordance with the types of the display panel. For example, in case of the LCD, the display 130 includes an LCD panel (not shown), a backlight unit (not shown) for illuminating the LCD panel (not shown), a panel driving substrate (not shown) for driving the LCD panel (not shown), etc.

The loudspeaker 140 makes a sound based on audio data processed by the signal processor 120. The loudspeaker 140 may include a unit loudspeaker provided corresponding to audio data of a specific audio channel, or a plurality of unit loudspeakers provided respectively corresponding to audio data of a plurality of audio channels.

The user input 150 may include various input circuitry that sends various preset control commands or information to the CPU 170 or the signal processor 120 in accordance to a user's manipulation or input. That is, the user input 150 delivers various events caused by a user's manipulation based on the user's intention to the CPU 170 or the signal processor 120.

The user input 150 may be achieved in various forms in accordance with methods of inputting information. For example, the user input 150 may include a user interface environment installed in the display apparatus 100, such as a key provided in the outside of the display apparatus 100, a touch screen provided in the display 130, a microphone (not shown) for receiving a user's utterance, a camera (not shown) for photographing or sensing an external environment of the display apparatus 100, etc. The remote controller (not shown) may be also regarded as one of the user interface environments. The remote controller (not shown) is separated from the main body of the display apparatus 100, and transmits a control signal to a control signal receiver (not shown) additionally provided in the main body of the display apparatus 100.

The storage 160 stores various pieces of data under process and control of the signal processor 120 or the CPU 170. The storage 160 is accessed by the CPU 170 and performs reading, writing, editing, deleting, updating or the like with regard to data. The storage 160 is achieved by a flash-memory, a hard-disc drive (HDD), a solid-state drive (SSD) or the like nonvolatile memory to preserve data regardless of supply of system power in the display apparatus 100.

As an example of data stored in the storage 160, there is a channel map. When a user inputs a specific channel number to the user input 150, the CPU 170 retrieves a frequency value corresponding to the channel number from the channel map stored in the storage 160, and sends the retrieved frequency value to the signal receiver 110. Thus, the signal receiver 110 receives a content signal tuned to a frequency based on the frequency value retrieved by the CPU 170.

The CPU 170 is an element for performing central calculation to operate general elements in the signal processor 120, and plays a central role in basically parsing and calculating data. The CPU 170 internally includes a processor register (not shown) in which commands to be processed are stored; an arithmetic logic unit (ALU) (not shown) being in charge of comparison, determination and calculation; a control unit (not shown) for internally controlling the CPU 170 to analyze and carry out the commands; an internal bus (not shown), a cache (not shown), etc.

The CPU 170 performs calculation needed for operating the elements of the signal processor 120. Alternatively, some elements of the signal processor 120 may be designed to operate without the data calculation of the CPU 170 or operate by a separate microcontroller (not shown).

With this structure, a user can have two methods of selecting a channel. One is that numeral keys of the remote controller are used to input a channel number of a channel desired by a user, and the other one is that keys provided on the outside of the display apparatus 100 or arrow keys of the remote controller corresponding to channel up or down are repetitively pressed by a user to search for channels. In the former method, the display apparatus can perform a direct tuning operation and thus quickly display an image of the channel desired by a user, but a user has to remember the channel number of the desired channel.

On the other hand, in the latter method of a so-called ‘channel zapping’, a user has to press the arrow keys many times until searching for a desired channel. In general, the channel zapping is to select one among many channels without giving a thought to a specific channel rather than intension of selecting the specific channel.

Since several hundreds of channels are currently available in reality, the channel zapping not only increases time taken in selecting a specific channel, but also increases the number of times a user has to press the arrow keys for selecting a specific channel. That is, the channel zapping is inconvenient for a user to select a desired channel.

Accordingly, if a service is provided to recommend a broadcast program to a user in response to a channel zapping operation of the user, it will be possible to solve problems of the user's inconvenience in the channel zapping operation. Below, an example embodiment related to this will be described.

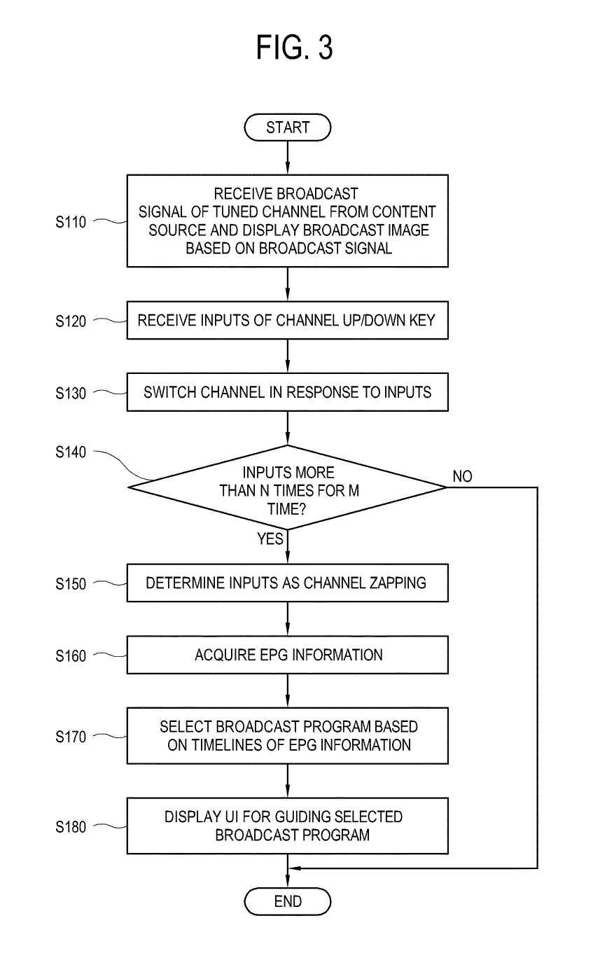

FIG. 3 is a flowchart illustrating an example of controlling a display apparatus according to a second example embodiment;

As illustrated in FIG. 3, the display apparatus according to the second example embodiment provides a recommendation service to a user in response to the channel zapping operation. The display apparatus in this example embodiment includes basically the same hardware components as those of the foregoing embodiments, and thus repetitive descriptions will be avoided.

At operation S110 the display apparatus receives a broadcast signal from a content source and displays a broadcast image of a specific channel.

At operation S120 the display apparatus receives an input of a channel up or down key from a remote controller.

At operation S130 the display apparatus switches channels for a broadcast signal in response to the input.

At operation S140 the display apparatus determines whether the channel up or down key is repetitively input N or more times for a preset time M in the remote controller. If it is determined that the channel up or down key is input N or more times for the preset time M, at operation S150 the display apparatus determines that channel zapping occurs.

Here, M and N are constant, and this determination is based on a control signal received from the remote controller. There are no limits to units of time M, and the time M may be given in units of secs or clocks.

Further, M and N may be varied depending on time taken in switching over to a channel corresponding to the channel up or down command of the remote controller received in the display apparatus and depending on conditions of a broadcast signal. For example, if the channel up or down key is input by 10 or more times for 5 seconds in a display apparatus of a manufacturer A in an area A, it is determined that channel zapping occurs to select one among many channels without previously giving a thought to a specific channel rather than intention of selecting a specific channel. On the other hand, if the channel up or down key is input by 8 or more times for 3 seconds in a display apparatus of a manufacturer B in the same area A, it is determined that channel zapping occurs.

Alternatively, if the channel up or down key is repetitively input again N times within M seconds after switching over to a channel in response to the input of the channel up or down key received from the remote controller, it may be determined that the channel zapping occurs. Even in this case, M and N are may be varied depending on the performance of the display apparatus and depending on the conditions of the broadcast signal.

At operation S160 the display apparatus acquires electronic program guide (EPG) information. The EPG information or interactive program guide (IPG) information may, for example, refer to a guide table for broadcasting programs of a TV, and includes information about broadcast programs corresponding to channels provided from the content sources in accordance with timelines. The EPG information may be displayed as a UI on the display apparatus, so that a user can select a specific broadcast program in the EPG information displayed as the UI.

The display apparatus may acquire the EPG information in accordance with various methods. For example, the EPG information may be involved in metadata of a broadcast signal, and the display apparatus acquires the EPG information from the metadata extracted from the broadcast signal. In addition, the EPG information may be given from a server through the Internet separately from the content source, and the display apparatus receives the EPG information from the server in accordance with the broadband mode. Of course, if the EPG information is previously stored, the display apparatus may call and use the previously stored EPG information.

At operation S170 the display apparatus selects one or more broadcast programs based on the timelines of the acquired EPG information. A method of selecting what kind of broadcast program will be described later.

At operation S180 the display apparatus displays a UI allowing a user to select one among the previously selected broadcast programs.

With this method, the display apparatus can recommend a broadcast program to a user.

The display apparatus may have many methods of selecting what kind of broadcast program. First, the display apparatus has to recommend a currently available broadcast program, and therefore basically selects the broadcast programs based on the timelines of the EPG information. In accordance with design methods, the display apparatus may select one broadcast program or two or more broadcast programs.

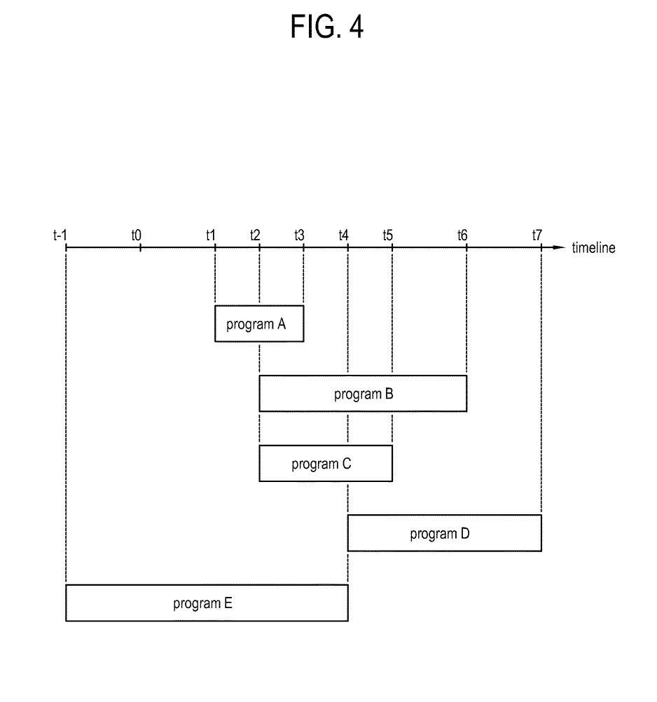

FIG. 4 is a diagram illustrating example EPG information acquired by the display apparatus according to the second example embodiment.

As illustrated in FIG. 4, the EPG information that can be called by the display apparatus includes start times and end times of broadcast programs in many channels with respect to timelines corresponding to a lapse of time. In the EPG information according to this example embodiment, with regard to a current time t0 on the timelines, a program A will be broadcasted from a time t1 to a time t3, a program B will be broadcasted from a time t2 to a time t6, a program C will be broadcasted from the time t2 to a time t5, a program D will be broadcasted from a time t4 to a time t7, and a program E is being broadcasted from a time t−1 to the time t4. Here, the earliest time is t−1, and the times t0 to t7 are sequentially shown as time passes.

For example, the display apparatus acquires the EPG information and selects one or more broadcast programs in accordance with conditions previously set with reference to the current time t0. Here, there are various conditions for selecting the broadcast program.

As one of methods, the display apparatus may select a program, which has the most preceding start time, among the programs to be broadcasted after the time t0. Under this condition, the display apparatus selects the program A to be started at the time t1.

As another one of the methods, the display apparatus may select a program, which has the longest running time, among the programs to be broadcasted within preset time after the time t0. Under this condition, the display apparatus selects the program B having the longest running time among the program A, the program B, the program C and the program D.

As still another one of the methods, the display apparatus may select a program, which belongs to the same genre as the program being currently viewed, among the programs to be broadcasted within preset time after the time t0. For example, if the genre of the program being currently viewed is sports and the genre of the program C is also sports, the display apparatus selects the program C.

As still another one of the methods, the display apparatus may select a program, which has metadata related to some information of the metadata of the program being currently viewed, among the programs to be broadcasted within preset time after the time t0. For example, if the metadata of the program D involves the same indexes as the metadata of the program being currently viewed, the display apparatus selects the program D.

As still another one of the methods, the display apparatus may select the most preceding program among programs having a remaining running time more than P%, even though the program is being previously broadcasted before the time t0. Here, P is a constant between ‘0’ and ‘100’. That is, the display apparatus selects a program, which does not run (100−P)% of the total running time after it starts to be broadcasted. If P=75, it means that the display apparatus selects a program, which does not run 25% of the total running time yet.

For example, the display apparatus selects the program E if a broadcast elapsed time of the program E starting at the time t−1 is not greater than a preset percentage.

As still another one of the methods, the display apparatus may select a program, which has the highest ratings, among available programs that can be broadcasted within preset time including the current time t0. For example, if there are five available programs A to E selectable with respect to the time t0, the display apparatus compares the ratings of the respective programs. If it is determined that the program D has the highest ratings among the five programs, the display apparatus selects the program D.

As still another one of the methods, the display apparatus may select a program based on separate reference information such as a user's view history. The reference information may include many parameters, and thus there are many ways of using the reference information to select a program. For example, if the view history includes a view record of a specific episode among a plurality of episodes that constitute a specific drama that a plurality of episodes, a specific program of the available programs may be one among the plurality of episodes of the corresponding drama. For example, if it is determined that the program E of the available programs is a specific episode of the drama having the view history, the display apparatus selects the program E.

Like this, the display apparatus selects the broadcast program under various conditions based on the time lines of the EPG information.

Below, it will be described that the display apparatus displays a UI for recommending the broadcast program selected as described above.

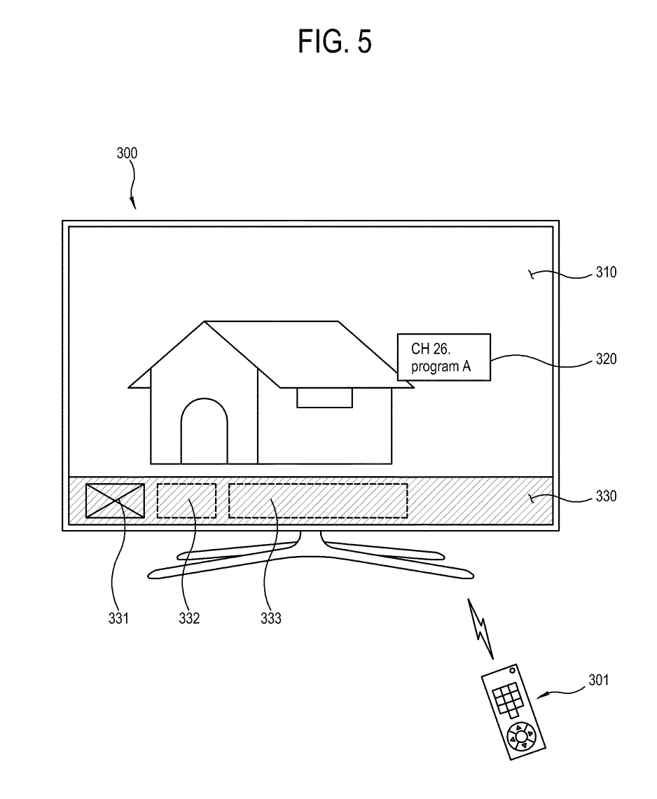

FIG. 5 is a diagram illustrating an example display apparatus 300 according to a third example embodiment that displays a broadcast image 310 and a guide user interface (UI) 330.

As illustrated in FIG. 5, the display apparatus 300 according to the third example embodiment receives a channel switching command from a remote controller 301, and displays the broadcast image 310 of a channel switched over corresponding to the command.

Here, the display apparatus 300 displays a guide UI 330 for guiding a broadcast program different from a program of the currently displayed broadcast image 310, in response to channel zapping from the remote controller 301. There are no limits to a position of displaying the guide UI 330, but it is preferable that interference between the position and the broadcast image 310 being currently displayed is as minimum as possible. For example, the display apparatus 300 may display the guide UI 330 in a lower portion of the broadcast image 310.

Further, the display apparatus 300 may display the guide UI 330 together with a channel banner 320 showing information related to the program of the broadcast image 310 currently displayed. For example, the channel banner 320 involves the information related to the program of the broadcast image 310 being currently displayed, such as a program title, a channel number, a program provider and the like information related to the program of the broadcast image 310.

That is, the channel banner 320 shows the information about the program of the currently displayed broadcast image 310, and the guide UI 330 guides a recommended program among programs different from the program of the currently displayed broadcast image 310. As the channel banner 320 is displayed together with the guide UI 330, a user can compare the information of the currently displayed broadcast program and the information of the broadcast program guided by the guide UI 330. However, in accordance with design methods, the display apparatus 300 may not display the channel banner 320 while displaying the guide UI 330.

The guide UI 330 includes information related to the recommended broadcast program. For example, the guide UI 330 involves a thumbnail image 331 of the recommended broadcast program, a title 332 of the broadcast program, description 333 for giving brief description of the broadcast program, etc. Besides, the information included in the guide UI 330 may include a variety of pieces of content, without being limited to this example embodiment.

If a user selects the guide UI 330 through the remote controller 301, the display apparatus 300 is tuned to a channel of a broadcast program guided by the guide UI 330 and processes a broadcast signal of the tuned channel, thereby displaying an image of the broadcast program guided by the guide UI 330.

If there are no inputs related to the guide UI 330 for preset time, the display apparatus 300 stops displaying display the guide UI 330. While the guide UI 330 is not displayed, the display apparatus 300 may also not display the channel banner 320.

Further, if a user moves a cursor or pointer to the guide UI 330 on a screen through the remote controller 301, the display apparatus 300 may sense it and display the guide UI 330 to be extended.

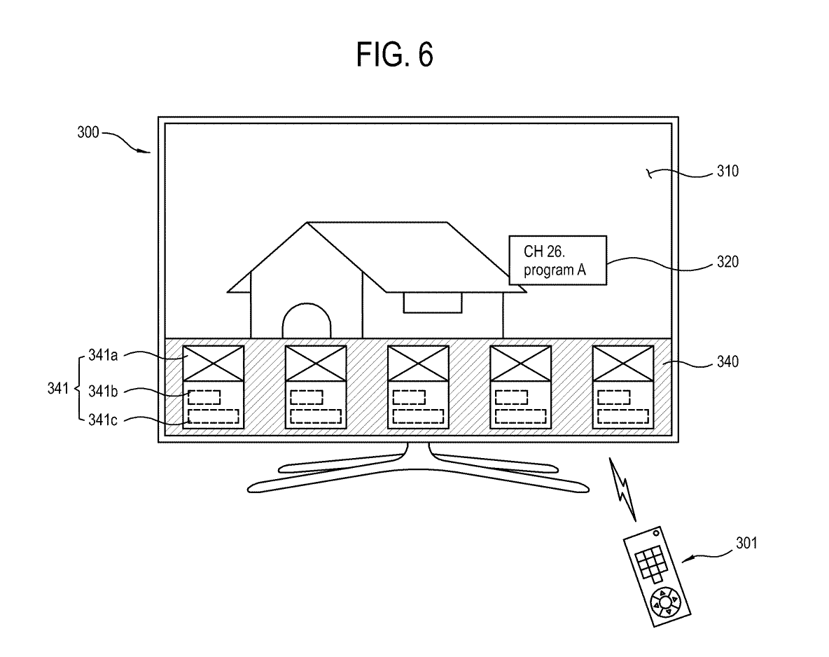

FIG. 6 is a diagram illustrating an example display apparatus 300 according to the third example embodiment that displays an extended guide UI 340.

As illustrated in FIG. 6, the display apparatus 300 may display the guide UI 340 to be extended on the broadcast image 310. The extended guide UI 340 is displayed in response to the movement of the cursor on the guide UI 330 as shown in FIG. 6.

The guide UI 330 guides one broadcast program, whereas the guide UI 340 extended as illustrated in FIG. 6 guides a plurality of broadcast programs. Likewise, the plurality of broadcast programs guided by the extended guide UI 340 may be also selected by the same methods as the foregoing example embodiments.

The extended guide UI 340 includes UI sections 341 respectively corresponding to the plurality of broadcast programs. One UI section 341 includes information related to one broadcast program, and for example includes a thumbnail image 341a of a recommended broadcast program, a title 341b of the broadcast program, a description 341c for giving brief description of the broadcast program, etc.

If one UI section 341 is selected in the extended guide UI 340 through the remote controller 301, the display apparatus 300 switches over to a broadcast program corresponding to the selected UI section 341 and displays an image of the corresponding broadcast program.

On the other hand, if there are no inputs on to the extended guide UI 340 within preset time, the display apparatus 300 stops displaying the extended guide UI 340. While the extended guide UI 340 is not displayed, the display apparatus 300 may also not display the channel banner 320.

The method of displaying the UI for recommending a broadcast program corresponding to channel zapping in the display apparatus is not limited to the foregoing example embodiment, and thus various methods of displaying the UI will be described below.

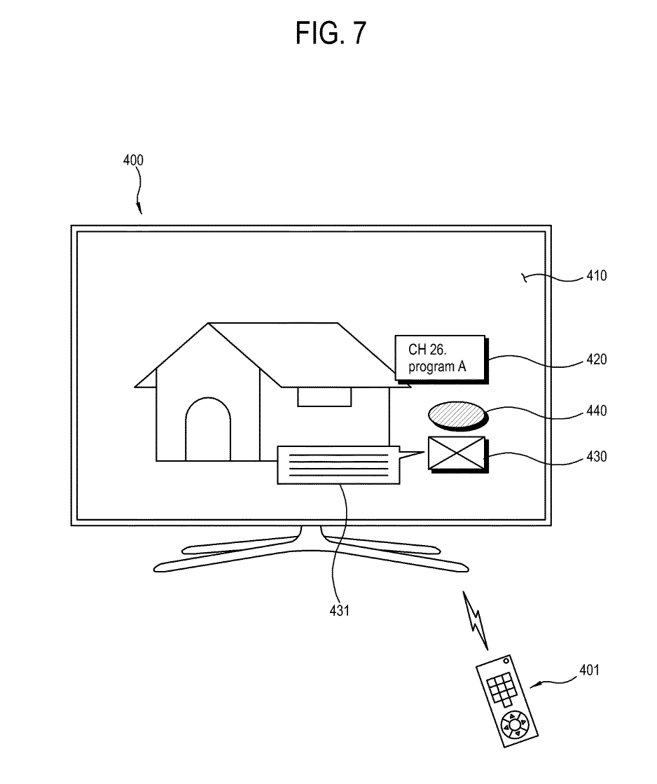

FIG. 7 is a diagram illustrating an example display apparatus 400 according to a fourth example embodiment that displays a guide UI 430 for showing additional information.

As illustrated in FIG. 7, the display apparatus 400 may additionally display information related to a recommended broadcast program in response to movement of a cursor toward the guide UI 430. The display apparatus 400 displays the guide UI 430 including only a thumbnail image of the recommended broadcast program in response to channel zapping. If the cursor is overlaid on the guide UI 430 in the state that the guide UI 430 is being displayed, the display apparatus 400 may additionally display an additional information window 431 including information such as the title, the description or the like of the recommended broadcast program.

The additional information window 431 includes information about the same program as the recommended broadcast program guided by the guide UI 430. That is, the guide UI 430 and the additional information window 431 include information about the same broadcast program.

Alternatively, the display apparatus 400 may additionally include a UI extension button 440 for extending the guide UI 430. When a user selects the UI extension button 440, the display apparatus 400 displays the guide UI 430 to be extended.

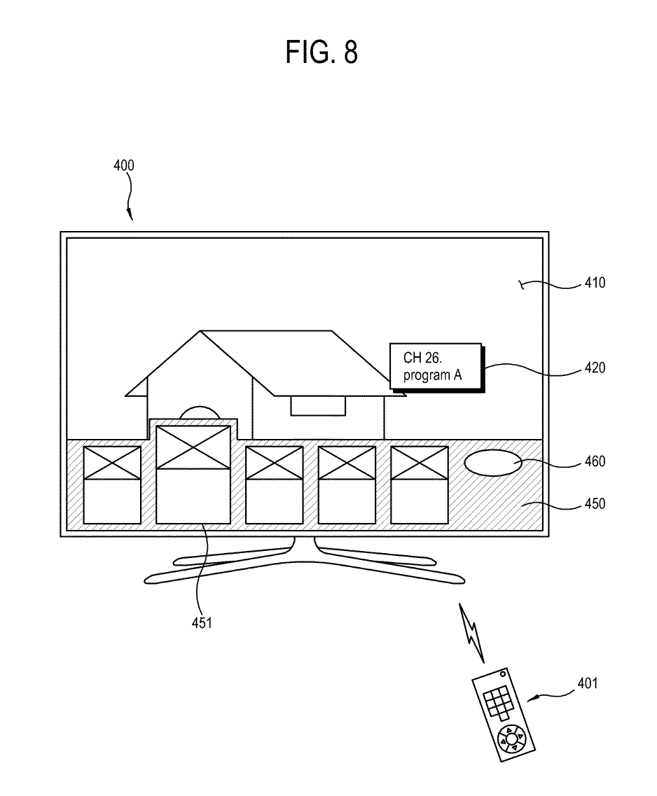

FIG. 8 is a diagram illustrating an example display apparatus 400 according to the fourth example embodiment that displays an extended guide UI 450.

As illustrated in FIG. 8, the display apparatus 400 may display the extended guide UI 450 on a broadcast image 410. The extended guide UI 450 may be displayed when a user clicks and selects the UI extension button 440 as previously illustrate in FIG. 7 through the remote controller 401.

On the contrary to that the guide UI 430 and the additional information window 431 as illustrated in FIG. 7 are used to guide one broadcast program, the extended guide UI 450 guides a plurality of broadcast programs. The plurality of broadcast programs guided by the extended guide UI 450 may be also selected by the same method as those of the foregoing example embodiments.

The extended guide UI 450 includes UI sections 451 respectively corresponding to the plurality of broadcast programs. Each of the UI sections 451 includes information about one broadcast program.

A user manipulates the remote controller 401 to select one UI section 451 among the plurality of UI sections 451. The UI section 451 currently selected among the plurality of UI sections 451 is more enlarged than the other UI sections 451 so that a user can easily identify the selected UI section 451. Alternatively, the currently selected UI sections 451 may be highlighted or be given different color.

If a user selects a specific UI section 451, the display apparatus 400 is tuned to a channel of a broadcast program corresponding to the selected UI section 451 and processes a broadcast signal of the tuned channel, thereby displaying an image of the corresponding broadcast program.

Further, the display apparatus 400 may additionally display a UI return button 460. If a user selects the UI return button 460, the display apparatus 400 returns back as illustrated in FIG. 7.

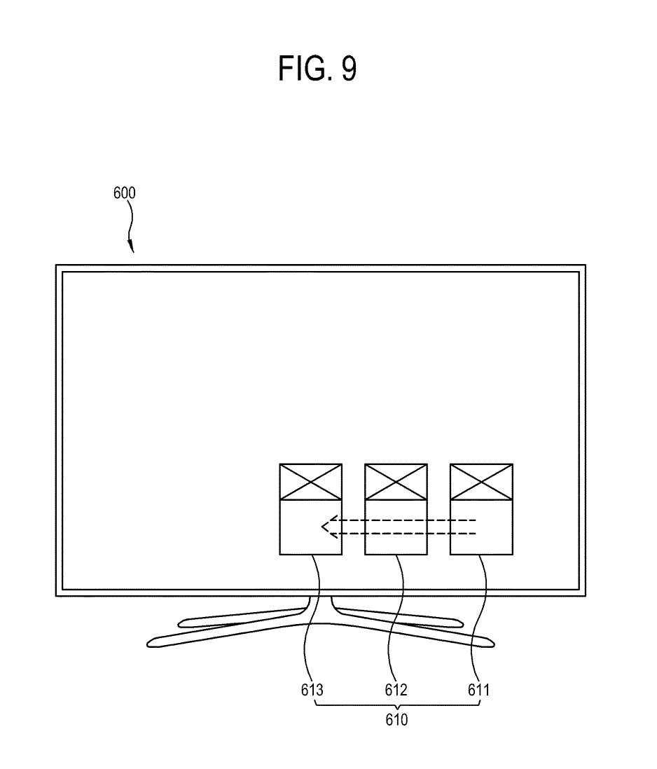

FIG. 9 is a diagram illustrating an example display apparatus 600 according to a fifth example embodiment that displays an extended guide UI 610.

As illustrated in FIG. 9, the display apparatus 600 according to the fifth example embodiment may display an extended guide UI 610. For example, when a separately provided UI button (not shown) is selected, the display apparatus 600 displays an extended guide UI 610 for guiding the plurality of broadcast programs.

For example, if only a UI section 611 corresponding to a specific broadcast program is first displayed on a right lower portion of the screen, the display apparatus 600 makes another UI section 612 move sliding from the UI section 611 and be displayed on the left side of the UI sections 611. Then, the display apparatus 600 makes still another UI section 613 move sliding from the UI section 611 and be displayed on the left side of the UI section 612. In this manner, the display apparatus 600 makes the plurality of UI sections 611, 612 and 613 move sliding in sequence and be arranged on the screen, thereby displaying the extended guide UI 610. Here, the extended guide UI 610 may denote, for example, that the guide UI is extended for selecting one among the plurality of broadcast programs on the contrary to the foregoing guide UI prepared for selecting one broadcast program.

In other words, the display apparatus 600 animates cards as if the cards are spread out one by one from a stack of cards, in which pieces of information are respectively recorded corresponding to a plurality of broadcast programs, and then arranged in a row.

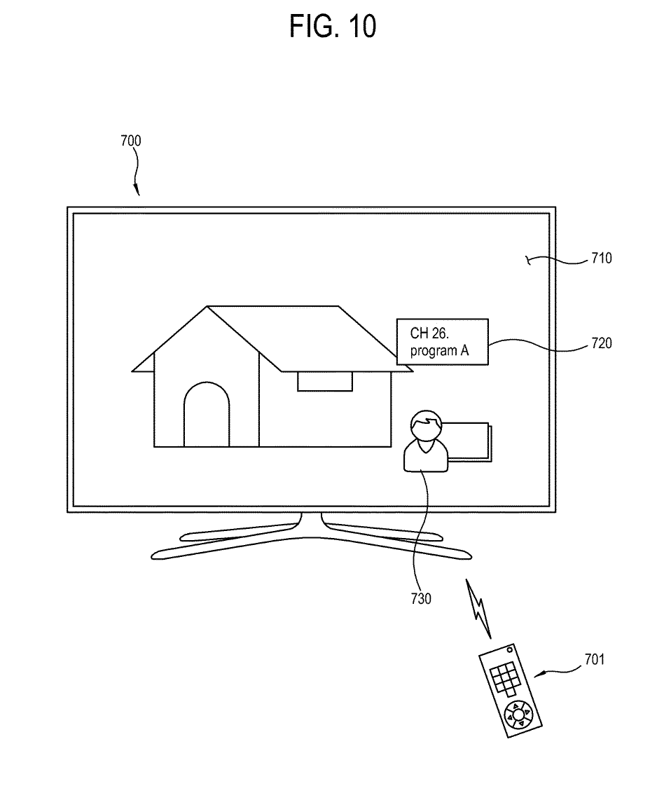

FIG. 10 is a diagram illustrating an example display apparatus 700 according to a sixth example embodiment displays a guide UI 730.

As illustrated in FIG. 10, the display apparatus 700 according to the sixth example embodiment receives a channel switching command from a remote controller 701, and displays a broadcast image 710 of a channel, which is switched over in response to the command, on a screen.

Here, the display apparatus 700 displays a guide UI 730 of guiding a broadcast program different from the program of the currently displayed broadcast image 710 in response to the channel zapping from the remote controller 701. Further, the display apparatus 700 may display the guide UI 730 together with a channel banner 720 related to the broadcast program of the broadcast image 710.

In the foregoing example embodiments, the guide UI 730 is represented by a rectangular window. However, there are no limits to the shape of the guide UI 730. For example, the guide UI 730 may have a freeform shape instead of a rectangular thumbnail image. For example, the thumbnail image has a rectangular shape and includes both a human or the like object and a background, whereas the guide UI 730 in this example embodiment includes only an object excluding the background from the thumbnail image. In this example, the broadcast image 710 is displayed on an area excluding the background on the screen.

As described above, the display apparatus may display the guide UI in various forms.

By the way, the foregoing example embodiments describe that the display apparatus displays the guide UI in response to the channel zapping from the remote controller. The reason why the display apparatus displays the guide UI is to determine that a user cannot make up his/her mind to view what kind of broadcast program, and recommend the currently available broadcast programs to him/her. In the foregoing example embodiments, the channel zapping is used as one of the factors for determining such a user's state.

However, it may be expected that a user cannot make up his/her mind to view what kind of broadcast program under a specific situation without detecting the channel zapping. If a specific situation is highly likely to cause the channel zapping, the display apparatus may show the guide UI to a user under this specific situation without monitoring the channel zapping.

In this regard, an example of situations, which cause the channel zapping while a broadcast program of a specific channel is displayed, will be described.

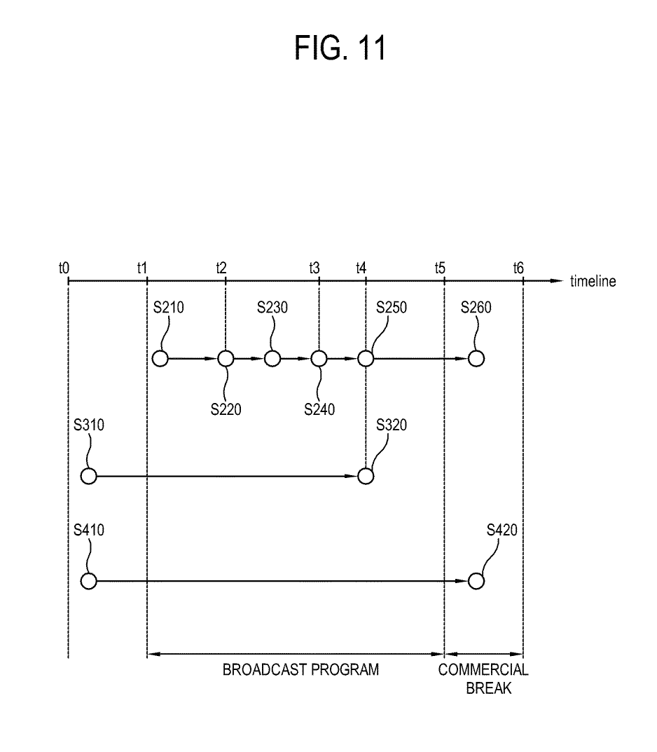

FIG. 11 is a diagram illustrating an example of channel zapping while a display apparatus according to a seventh example embodiment displays a broadcast program of a certain channel.

As illustrated in FIG. 11, while the display apparatus displays a broadcast program of a specific channel in accordance with timelines, a user may make the channel zapping for various reasons at many points of time through the remote controller. In this example embodiment, the time and reason of the channel zapping are not specific. Further, there are various intentions according to users, and therefore the channel zapping may be variously performed differently from this example embodiment. In this example embodiment, a situation, which is highly likely to cause the channel zapping, will be anticipated. In FIG. 11, circles illustrated along the timelines refer to that a user makes the channel zapping at corresponding points of time along the timelines.

The display apparatus is turned on at a time t0. A broadcast program of a specific channel starts to be broadcasted at a time t1. A total running time of the broadcast program may include a commercial break at times t2 and t3. At a time t4, a preset running time of the broadcast program remains in the total running time. The broadcast program is ended at a time t5, and a new broadcast program starts to be broadcasted at a time t6 with a commercial break between the times t5 and t6.

For example, a first user selects a broadcast program through channel zapping after the time t1 (S210), and continues to view the broadcast program. If the commercial break appears at the time t2, the first user who is viewing the broadcast program may make channel zapping to check whether there is anything good on other channels during the commercial break (S220).

Alternatively, the first user may make the channel zapping at any time even while the broadcast program runs without commercial breaks (S230).

The first user may make the channel zapping if a commercial break appears again at the time t3 (S240). Alternatively, the first user may make the channel zapping to search for another broadcast program at the time t4 where the running time of the broadcast program remains small (S250).

At the time t5 where the broadcast program is ended and a commercial break appears, the first user makes the channel zapping to search for a broadcast program to be viewed next (S260).

By the way, a second user may make the channel zapping between the time t0 and the time t1 (S310), and continue to view the broadcast program by selecting the broadcast program. At the time t4 where the running time of the broadcast program remains small until it is ended, the second user may make the channel zapping to search for a new broadcast program (S320).

In addition, a third user may make the channel zapping between the time t0 to the time t1 (S410), and select the broadcast program to view the broadcast program until the broadcast program is ended at the time t5. During the commercial break after the time t5, the third user may make the channel zapping to search for a broadcast program to be viewed next (S420).

Taking various situations of such users into account, it will be expected that the channel zapping is generally caused as follows.

The channel zapping may be performed within preset time after the display apparatus is turned on. If the display apparatus is turned on, a user makes channel zapping to select which broadcast program will be viewed. Alternatively, the channel zapping may be performed during the commercial break in the broadcast program or between the broadcast programs. Alternatively, the channel zapping may be performed when the remaining running time of the currently viewed broadcast program is not greater than a preset percentage of the total running time. In this case, the broadcast program will be ended soon, and thus a user is likely to search for another broadcast program rather than view the current broadcast program.

Of course, there may be various situations in addition to the foregoing situations where a user is expected to make the channel zapping.

Thus, a user makes the channel zapping for various reasons at various points of time. In this regard, the display apparatus may display a guide UI for recommending a broadcast program at a time when the channel zapping is expected even though the channel zapping is not actually performed.

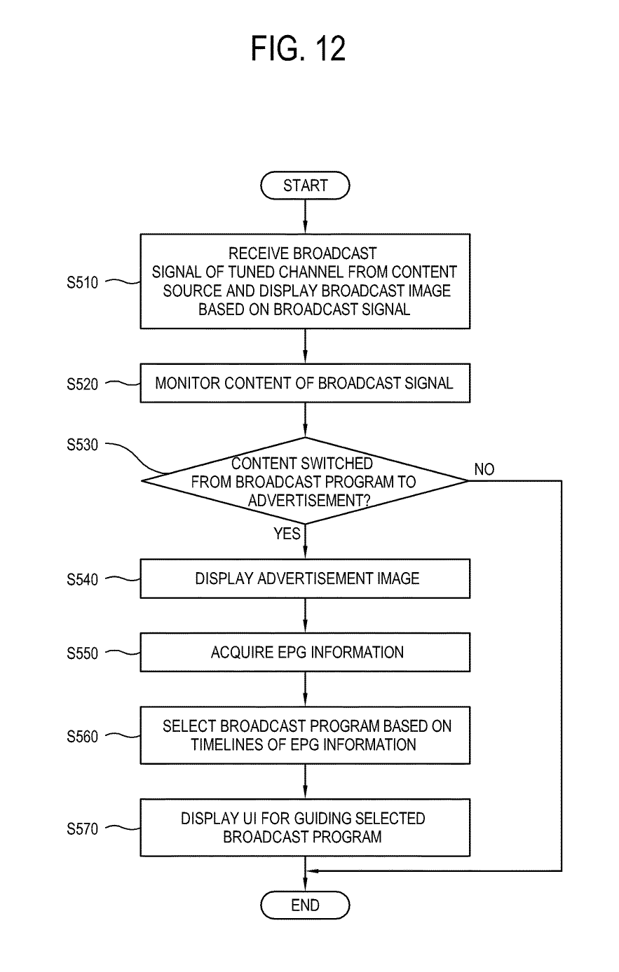

FIG. 12 is a flowchart illustrating an example of controlling a display apparatus according to an eighth example embodiment.

As illustrated in FIG. 12, at operation S510 the display apparatus according to the eighth example embodiment is tuned to a specific channel and receives a broadcast signal corresponding to the tuned channel from a content source, thereby displaying a broadcast image.

At operation S520 the display apparatus monitors content in the broadcast signal.

At operation S530 the display apparatus determines whether the content of the broadcast signal is switched over from a broadcast program to an advertisement. If the content of the broadcast signal is the broadcast program, the display apparatus continues to display an image of the broadcast program.

On the other hand, if the content of the broadcast signal is switched over from the broadcast program to the advertisement, at operation S540 the display apparatus displays an advertisement image.

At operation S550 the display apparatus acquires the EPG information.

At operation S560 the display apparatus selects one or more broadcast programs based on the timelines of the acquired EPG information.

At operation S570 the display apparatus displays a UI for recommending and guiding one or more selected broadcast programs.

In this manner, the display apparatus can display a UI for recommending a broadcast program if a specific condition is satisfied even though a user does not make the channel zapping. In this example embodiment, such a specific condition is a case that the advertisement is displayed. Besides, there are various conditions as described with reference to FIG. 11.

The UI for recommending the broadcast program may be displayed only when an additional condition is satisfied, even though the channel up or down key of the remote controller is pressed more than a preset number of times. For example, if a user successively presses the channel up or down key to select a specific channel, there may be no need of providing the UI for recommending the broadcast program.

In this regard, the display apparatus may not display the UI in response to generally periodic successive inputs of the channel up or down key, but display the UI in response to generally aperiodic successive inputs of the channel up or down key.

Further, the display apparatus may additionally use a user history in selecting the broadcast program to be recommended based on the timelines of the EPG information.

Here, a user's use history may be unrelated or related to the view history of the broadcast program recommended by the previous guide UI.

In the former case, a user's use history includes ranking information of a broadcast program, which has been the most frequently viewed or has the most accumulated view time, among various broadcast programs that have been viewed by the user. Thus, the display apparatus selects a program, which has been the most frequently viewed or has the most accumulated view time, based on a user's use history among the plurality of broadcast programs selected through the EPG information as the recommended broadcast program.

In the latter case, a user's use history includes a user's preference for the broadcast program recommended through the guide UI. That is, a user's use history in this case is related to only the broadcast programs that have been previously recommended through the guide UI. A user's use history gives a high priority to a recommended broadcast program when the user has selected the broadcast program through the guide UI and viewed the broadcast program more than preset time. On the other hand, a user's use history gives a low priority to a recommended broadcast program or excludes the broadcast program from a ranking list when the user has selected the broadcast program through the guide UI but viewed the broadcast program less than the preset time and made the channel zapping.

In such a manner, the display apparatus may select a recommended broadcast program, in which a user's preference is more reflected, and provide the recommended broadcast program to a user.

The methods according to the foregoing example embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the example embodiments. The program command recorded in this storage medium may be specially designed and configured according to the example embodiments, or may be publicly known and available to those skilled in the art of computer software.

Although various example embodiments have been illustrated and described, it will be appreciated by those skilled in the art that changes may be made in these example embodiments without departing from the principles and spirit of the disclosure, the scope of which is defined in the appended claims and their equivalents.

What is claimed is:

1. A display apparatus comprising:
a display;
a signal receiver configured to receive a broadcast signal;
an input comprising input circuitry including a channel changing key and configured to receive an input; and
at least one processor configured to display an image of a first channel among a plurality of channels of the received broadcast signal on the display, and to switch from the first channel to another channel in response to a channel changing command input through the input while the image of the first channel is displayed,
the at least one processor configured to process a user interface (UI) for guiding a second channel to be selectable to be displayed on the display if the channel changing key is input more than a predetermined number of times for a preset first time.

2. The display apparatus according to claim 1, wherein the at least one processor is configured to process the UI for guiding the second channel to be selectable to be displayed on the display if the channel changing key is input more than a predetermined number of times within a preset second time after the first channel is switched to another channel.

3. The display apparatus according to claim 1, wherein the at least one processor is configured to process the UI for guiding the second channel to be selectable to be displayed on the display if the channel changing key is input during a commercial break or if a remaining running time of a program displayed corresponding to the first channel is not greater than a predetermined value.

4. The display apparatus according to claim 1, wherein the at least one processor is configured to select a channel of a broadcast program, which is selected based on preset priority, as the second channel among broadcast programs that can be broadcast between a current time and a preset second time.

5. The display apparatus according to claim 4, wherein the priority is determined by a preference based on a view history of a broadcast program.

6. The display apparatus according to claim 4, wherein the priority is determined by ratings of a broadcast program.

7. The display apparatus according to claim 4, wherein the priority is determined by similarity in genre of a broadcast program.

8. The display apparatus according to claim 1, wherein the at least one processor is configured to process the UI for guiding the second channel to be selectable to be displayed on the display with respect to aperiodic inputs of the channel changing key.

9. The display apparatus according to claim 1, wherein the input comprises a remote controller, and
the channel changing command is issued by an input of the channel changing key provided in the remote controller.

10. A method of controlling a display apparatus, the method comprising:
receiving a broadcast signal;
displaying an image of a first channel among a plurality of channels of the broadcast signal;
receiving an input comprising a channel changing command while the image of the first channel is displayed;
switching from the first channel to another channel in response to the channel changing command; and
displaying a user interface (UI) for guiding a second channel to be selectable if a channel changing key provided in a remote controller for the display apparatus is input more than a predetermined number of times for a preset first time.

11. The method according to claim 10, wherein the displaying the UI comprises displaying the UI for guiding the second channel to be selectable if the channel changing key is input more than a predetermined number of times within a preset second time after the first channel is switched to another channel.

12. The method according to claim 10, wherein the displaying the UI comprises displaying the UI for guiding the second channel to be selectable if the channel changing key is input during a commercial break or if a remaining running time of a program displayed corresponding to the first channel is not greater than a predetermined value.

13. The method according to claim 10, wherein the displaying the UI comprises selecting a channel of a broadcast program, which is selected based on preset priority, as the second channel among broadcast programs that can be broadcast between a current time and a preset second time.

14. The method according to claim 13, wherein the priority is determined by a preference based on a view history of a broadcast program.

15. The method according to claim 13, wherein the priority is determined by ratings of a broadcast program.

16. The method according to claim 13, wherein the priority is determined by similarity in genre of a broadcast program.

17. The method according to claim 10, wherein the displaying the UI comprises displaying the UI for guiding the second channel to be selectable with respect to aperiodic inputs of the channel changing key.
